(19) United States
(12) Patent Application Publication
(10) Pub. No.: US 2014/0104101 A1
(43) Pub. Date: Apr. 17, 2014

(54) POSITION CALCULATING METHOD AND POSITION CALCULATING DEVICE

(71) Applicant: Shunichi Mizuochi, Matsumoto-shi (JP)

(72) Inventor: Shunichi Mizuochi, Matsumoto-shi (JP)

(73) Assignee: Seiko Epson Corporation, Shinjuku-ku, Tokyo (JP)

(21) Appl. No.: 14/008,839

(22) PCT Filed: Mar. 12, 2012
(86) PCT No.: PCT/JP2012/001692

§ 371 Date: Dec. 10, 2013

(30) Foreign Application Priority Data
Apr. 1, 2011 (JP) 2011-081418

(51) Int. Cl. G01S 19/47

(52) U.S. Cl. CPC G01S 19/47
USPC 342/357.3

(57) ABSTRACT

A position calculating device of a moving object including a satellite positioning unit and an inertial positioning unit sets an influence level of measurement result 1 of the satellite positioning unit on measurement result 2 of the inertial positioning unit to a first level until a given condition is established after position calculation is started, and sets the influence level to a second level after the given condition is established. The position of the moving object is calculated by performing a coupling process of coupling measurement result 1 and measurement result 2 on the basis of the set influence level.

This application is a National Phase of international Application No. PCT/JP2012/001692, filed Mar. 12, 2012, which claims priority to Japanese Patent Application No. 2011-081418, filed Apr. 1, 2011, the entireties of which are hereby incorporated by reference.

### BACKGROUND

1. Technical Field

The present invention relates to a position calculating method and the like using measurement results of a satellite positioning unit and an inertial positioning unit which are disposed in a moving object.

2. Related Art

In various fields related to so-called seamless positioning, motion sensing, and posture control, use of an inertial sensor has attracted attention. An acceleration sensor, a gyro sensor, a pressure sensor, a geomagnetic sensor, and the like are widely used as the inertial sensor. An inertial navigation system (hereinafter, referred to as “INS”) has also been invented which performs an inertial navigation operation using detection results of the inertial sensor.

In the INS, there is a problem in that position calculation accuracy is lowered due to various error components which can be included in the detection results of an inertial sensor, and various techniques for improving the position calculation accuracy have been invented. For example, US 2010/0019963 discloses a technique of correcting an INS operation result using a GPS (Global Positioning System).

### SUMMARY

The technique of correcting the INS operation result using the GPS is on the premise that the GPS operation result is correct. The same is true of the technique disclosed in US 2010/0019963. However, the GPS operation result may be lowered in operation result accuracy due to various factors such as signal intensities and reception environments of GPS satellite signals received from GPS satellite, arrangement of GPS satellites in the sky, and multipath. Accordingly, the correction of the INS operation result using the GPS operation result cannot be necessarily said to cause improvement in position calculation accuracy.

The invention is made in consideration of the above-mentioned circumstances and an object thereof is to provide a technique of more accurately calculating a position of a moving object using measurement results of a satellite positioning unit and an inertial positioning unit which are disposed in the moving object together.

According to a first aspect of the invention for achieving the above-mentioned object, there is provided a position calculating method of calculating a position of a moving object using a first measurement result of a satellite positioning unit disposed in the moving object and a second measurement result of an inertial positioning unit disposed in the moving object, including: setting an influence level of the first measurement result on the second measurement result to a first level until a given condition is established after position calculation is started, and setting the influence level to a second level lower than the first level after the given condition is established; and calculating the position of the moving object by performing a coupling process of coupling the first measurement result and the second measurement result on the basis of the influence level.

According to another aspect of the invention, there is provided a position calculating device calculating a position of a moving object using a first measurement result of a satellite positioning unit disposed in the moving object and a second measurement result of an inertial positioning unit disposed in the moving object, including: an influence level setting unit that sets an influence level of the first measurement result on the second measurement result to a first level until a given condition is established after position calculation is started, and sets the influence level to a second level lower than the first level after the given condition is established; and a coupling unit that calculates the position of the moving object by performing a coupling process of coupling the first measurement result and the second measurement result on the basis of the influence level.

According to the first aspect and the like of the invention, the influence level of the first measurement result on the second measurement result is set to the first level until a given condition is established after starting the position calculation. After the given condition is established, the influence level is set to the second level lower than the first level. That is, before and after the given condition is established, the influence level of the measurement result of the satellite positioning unit on the measurement result of the inertial positioning unit is changed. Accordingly, the influence level in the initial operation can be appropriately adjusted. It is possible to improve position calculation accuracy by performing the coupling process of coupling the first measurement result and the second measurement result on the basis of the appropriately-adjusted influence level.

As a second aspect of the invention, the position calculating method according to the first aspect may be configured such that the influence level includes a frequency of performing the coupling process using the first measurement result, the setting to the first level includes setting the frequency to a first frequency, the setting to the second level includes setting the frequency to a second frequency lower than the first frequency, and the calculating of the position includes performing the coupling process using the first measurement result on the basis of the frequency.

According to the second aspect, the frequency of performing the coupling process using the first measurement result is set to the first frequency until the given condition is established. After the given condition is established, the frequency is set to the second frequency lower than the first frequency. That is, after the given condition is established, the frequency using the first measurement result for the coupling process is lowered to lower the influence level of the first measurement result on the second measurement result. Accordingly, by appropriately adjusting the frequency using the measurement result of the satellite positioning unit for the coupling process, it is possible to enhance effectiveness of the coupling process.

As a third aspect of the invention, the position calculating method according to the first aspect may be configured such that the coupling process includes a Kalman filtering process using the first measurement result as an observable, the influence level includes an error parameter value used in the Kalman filtering process, the setting to the first level includes setting the error parameter value to a first parameter value, the setting to the second level includes setting the error parameter value to a second parameter value larger than the first parameter value, and the calculating of the position includes performing the Kalman filtering process using the first measurement result and the error parameter value.

According to the third aspect, the error parameter value used for the Kalman filtering process is set to the first parameter value until the given condition is established. After the given condition is established, the error parameter value is set to the second parameter value larger than the first parameter value. The error parameter value is, for example, a value for determining a degree by which the first measurement result is emphasized in the Kalman filtering process. The setting of the error parameter value to be large corresponds to the lowering of the influence level of the first measurement result on the second measurement result. By appropriately adjusting the error parameter value, it is possible to enhance the accuracy in the calculated position of the moving object.

As a fourth aspect of the invention, the position calculating method according to the first aspect may be configured such that the calculating of the position includes calculating the position by performing a predetermined position calculating process using the first measurement result when the influence level is set to the first level, and calculating the position by performing the coupling process when the influence level is set to the second level.

According to the fourth aspect, the position is calculated by performing a predetermined position calculating process using the first measurement result when the influence level is set to the first level. On the other hand, when the influence level is set to the second level, the position is calculated by performing the coupling process. Accordingly, it is possible to calculate the position of the moving object by applying a position calculation scheme suitable for the influence level.

As a fifth aspect of the invention, the position calculating method according to any one of the first to third aspects may be configured such that the setting of the influence level includes determining that the given condition is established when the elapsed time after the position calculation is started or the position calculation frequency satisfies an accuracy stabilizing condition determined as a temporal condition for stabilizing the accuracy of the position calculation result.

According to the fifth aspect, the influence level of the first measurement result on the second measurement result is lowered from the first level to the second level, when the elapsed time after the position calculation is started or the position calculation frequency satisfies the accuracy stabilizing condition determined as a temporal condition for stabilizing the accuracy of the position calculation result. Accordingly, after it is determined that the accuracy of the position calculation result is stabilized, the dependency on the measurement result of the satellite positioning unit can be reduced to calculate the position.

As a sixth aspect of the invention, the position calculating method according to any one of the first to third aspects may be configured such that the calculating of the position includes setting the position calculated from the first measurement result at the time of starting the position calculation as a reference position for subsequent position calculation, and the setting of the influence level includes determining that the given condition is established when the first measurement result at the time of starting the position calculation satisfies a predetermined excellent accuracy condition.

According to the sixth aspect, the subsequent position calculation is performed using the position calculated from the first measurement result at the time of starting the position calculation as a reference position. That is, when the accuracy of the first measurement result is excellent, the subsequent position calculation can be performed using the position closer to the true position as a reference position. Therefore, when the first measurement result at the time of starting the position calculation satisfies the predetermined excellent accuracy condition, the influence level is lowered from the first level to the second level. Accordingly, when it can be determined that a reference position with high reliability is obtained, the dependency on the measurement result of the satellite positioning unit can be reduced to calculate the position.

As a seventh aspect of the invention, the position calculating method according to any one of the first to third aspects may be configured such that the setting of the influence level includes determining that the given condition is established when the result of the coupling process satisfies a predetermined excellent accuracy condition.

According to the seventh aspect, the influence level is lowered from the first level to the second level when the result of the coupling process satisfies the predetermined excellent accuracy condition. Accordingly, when it is determined that an accuracy of the result of the coupling process is excellent, the dependency on the measurement result of the satellite positioning unit can be reduced to calculate the position.

### BRIEF DESCRIPTION OF THE DRAWINGS

FIG. 1 is a diagram illustrating a principal configuration of a position calculating device.

FIG. 2 is a diagram illustrating a configuration of a first position calculating device.

FIG. 3 is a diagram illustrating input and output data in a coupling process.

FIG. 4 is a diagram illustrating a first mode setting condition.

FIG. 5 is a diagram illustrating a second mode setting condition.

FIG. 6 is a flowchart illustrating the flow of an influence mode setting process.

FIG. 7 is a diagram illustrating an example of an experiment result of position calculation.

FIG. 8 is a diagram illustrating an example of an experiment result of position calculation.

FIG. 9 is a diagram illustrating an example of an experiment result of position calculation.

FIG. 10 is a diagram illustrating an example of an experiment result of position calculation.

FIG. 11 is a diagram illustrating a system configuration of a navigation system.

FIG. 12 is a block diagram illustrating a functional configuration of a car navigation apparatus.

FIG. 13 is a diagram illustrating a table configuration of an operation setting table.

FIG. 14 is a flowchart illustrating the flow of a first navigation process.

FIG. 15 is a flowchart illustrating the flow of a coupling process.

FIG. 16 is a flowchart illustrating the flow of a second navigation process.

### DESCRIPTION OF EXEMPLARY EMBODIMENTS

Hereinafter, an example of an exemplary embodiment of the invention will be described with reference to the accompanying drawings. In this embodiment, position calculation is performed using a GPS (Global Positioning System) which is a kind of a satellite positioning system and an INS (Inertial Navigation System) which is a system for performing an inertial navigation operation together.

1. Principle

1.1. Configuration

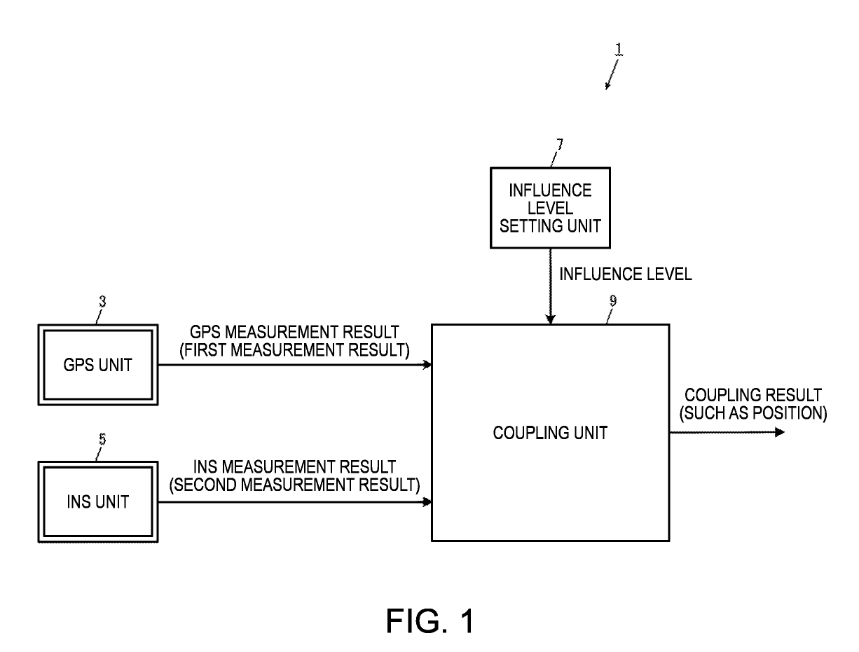

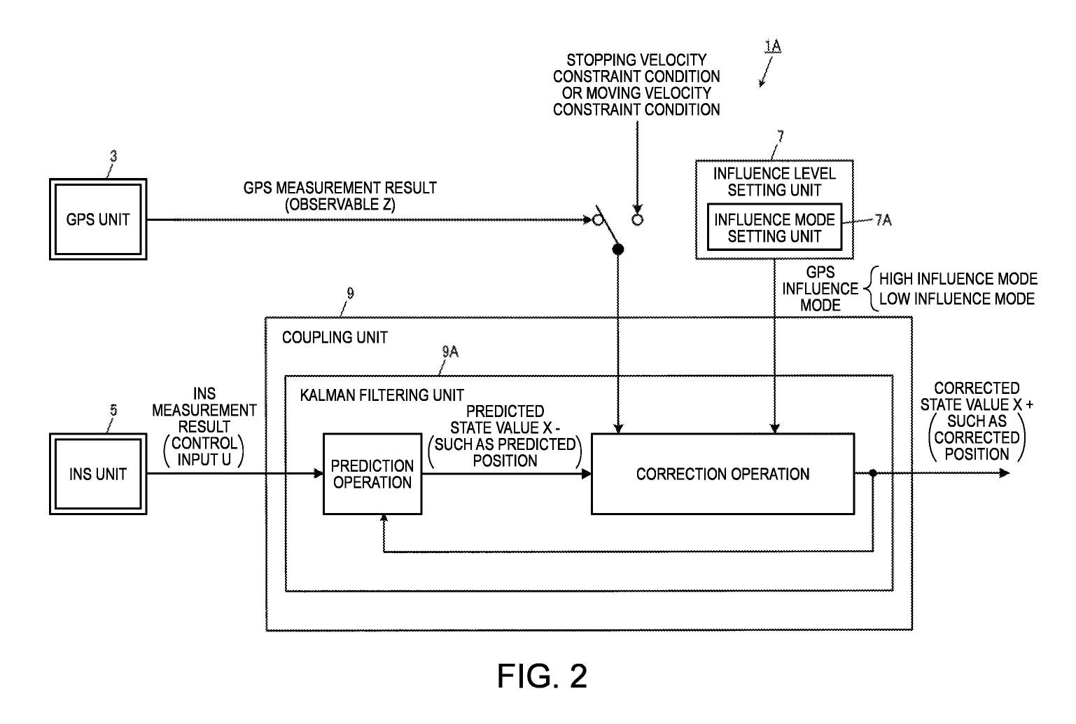

FIG. 1 is a diagram illustrating a principal configuration of a position calculating device 1 according to this embodiment. The position calculating device 1 is a device (position calculating system) which is disposed in a moving object so as to calculate the position of the moving object. Examples of the moving object include a person himself in addition to an automobile, a motorcycle, a bicycle, a ship, and a train. A person may carry the position calculating device 1 and the person itself may include the position calculating device 1. In FIG. 1, a unit (module) is indicated by a double line and a processing block performing an operation using the measurement result of the unit is indicated by a single line, so as to distinguish both from each other. The same is true of FIG. 2.

The position calculating device 1 includes a GPS unit 3 and an INS unit 5 as units (modules). The position calculating device 1 includes an influence level setting unit 7 and a coupling unit 9 as principal processing blocks.

The GPS unit 3 is a unit (satellite positioning unit) that performs a positioning operation using a satellite position system. The GPS unit 3 includes an antenna receiving GPS satellite signals transmitted from GPS satellites, a processor processing the received GPS satellite signals and the like.

The GPS unit 3 is configured to measure GPS measurement information such as code phases or Doppler frequencies of the GPS satellite signals, a pseudo-distance, and a pseudo-distance variation. The GPS unit 3 is also configured to perform a GPS operation using the GPS measurement information and to measure the position, the velocity (velocity vector) and the like of a moving object. The GPS measurement information or the GPS operation result is output as the GPS measurement result (first measurement result) to the coupling unit 9.

The INS unit 5 is a unit (inertial positioning unit) that performs a positioning operation using an inertial navigation. The INS unit 5 includes an inertial sensor such as an acceleration sensor or a gyro sensor, an inertial measurement unit (IMU) obtained by packaging the inertial sensor, and a processor processing the measurement result of the inertial sensor.

The INS unit 5 is configured to measure an acceleration (acceleration vector), an angular velocity or the like of a moving object as NS measurement information using the measurement result of the inertial sensor. The INS unit 5 is configured to perform an inertial navigation operation (INS operation) using the INS measurement information and to measure the position, the velocity (velocity vector), the posture angle, and the like of the moving object. The INS measurement information or the INS operation result is output as INS measurement result (second measurement result) to the coupling unit 9.

The influence level setting unit 7 sets an influence level of the GPS measurement result (first measurement result) on the NS measurement result (second measurement result). The influence level setting unit 7 determines whether a given condition is established after the position calculation is started. Then, the influence level setting unit sets the influence level of the GPS measurement result on the INS measurement result to a first level until the given condition is established, and sets the influence level to a second level lower than the first level after the given condition is established.

The coupling unit 9 calculates the position of a moving object or the like by performing a coupling process of coupling the GPS measurement result (first measurement result) and the INS measurement result (second measurement result) on the basis of the influence level set by the influence level setting unit 7.

FIG. 2 is a diagram illustrating the configuration of a first position calculating device 1A employing the position calculating device 1 shown in FIG. 1. In the first position calculating device 1A, the influence level setting unit 7 shown in FIG. 1 includes an influence mode setting unit 7A and the coupling unit 9 includes a Kalman filtering unit 9A.

The influence mode setting unit 7A sets a GPS influence mode depending on a mode setting condition to be described later. The GPS influence mode is a mode for determining the influence level of the GPS. In this embodiment, it is assumed that two types of modes of a “high influence mode” which is a mode having a relatively high influence level of the GPS measurement result on the INS measurement result and a “low influence mode” which is a mode having a relatively low influence level of the GPS measurement result on the INS measurement result are alternatively set. It is assumed that the high influence mode is set at the initial setting.

The Kalman filtering unit 9A performs a Kalman filtering process using the GPS measurement result as an observable “Z” to couple the GPS measurement result and the INS measurement result. Specifically, a prediction operation (time update) and a correction operation (observation update) are performed on the basis of the theory of Kalman filter to estimate a moving object state “X”.

In this embodiment, the moving object state “X” includes at least the position of the moving object. In the prediction operation, for example, an operation of predicting the state “X” at the present time (at this time) from a corrected state value “X+” at the one-before time (previous time) using the NS measurement result input from the INS unit 5 as a control input “U” is performed to calculate a predicted state value “X−”.

In the correction operation, for example, an operation of correcting the predicted state value “X−” calculated in the prediction operation using the GPS measurement result input from the GPS unit 3 as an observable “Z” is performed to calculate a corrected state value “X+”. The calculated corrected state value “X+” is output as the coupling result.

The Kalman filtering unit 9A is configured to apply a constraint condition based on a movement model of a moving object as the observable “Z” independently of the GPS measurement result. In this embodiment, it is assumed that two types of velocity constraint conditions of a “stopping velocity constraint condition” which is a velocity constraint condition when the moving object stops and a “moving velocity constraint condition” which is a velocity constraint condition when the moving object moves are applied.

The stopping velocity constraint condition (first constraint condition) is a constraint condition which can be applied when a moving object stops. When a moving object stops, the velocity of the moving object is ideally zero. Therefore, when it is determined that the moving object stops, the “velocity component of a moving object for each axis=0 (velocity vector=zero vector)” can be given as the observable “Z”.

The moving velocity constraint condition (second constraint condition) is a constraint condition which can be applied when a moving object moves. For example, when a four-wheeled automobile is assumed as the moving object, it can be generally assumed that the four-wheeled automobile does not jump nor slides laterally. Therefore, when it is determined that a moving object moves, the “velocity component of a moving object for each of vertical and lateral directions=0” can be given as the observable “Z”.

In this embodiment, for example, the GPS measurement result and the constraint condition (the stopping velocity constraint condition or the moving velocity constraint condition) are switched and used as the observable “Z”. Unlike in this embodiment, the GPS measurement result and the constraint condition may be used together as the observable “Z”.

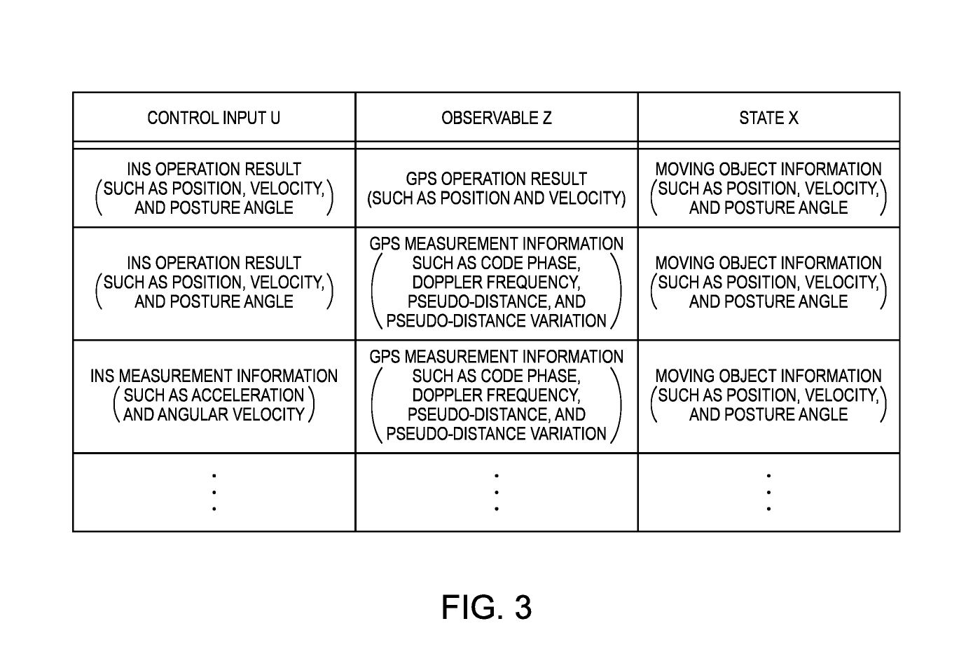

FIG. 3 is a diagram illustrating input and output data in the Kalman filtering process. In the drawing, a table representing correlations of a control input “U”, an observable “Z”, and a state “X” is shown. There are various coupling methods. Among these, a method called loose coupling (sparse coupling) and a method called tight coupling (dense coupling) are generally used.

The loose coupling method is a coupling method in which the coupling of the GPS and the INS is relatively weak. In this method, for example, the coupling process is performed using the INS operation result (such as a position, a velocity, and a posture angle) as the control input “U” and using the GPS operation result (such as a position and a velocity) as the observable “Z”. Moving object information (such as a position, a velocity, and a posture angle) is estimated as the state “X”.

The tight coupling method is a coupling method in which the coupling of the GPS and the INS is relatively strong. In this method, for example, the coupling process is performed using the INS operation result (such as a position, a velocity, and a posture angle) as the control input “U” and using the GPS measurement information (such as a code phase, a Doppler frequency, a pseudo-distance, and a pseudo-distance variation) as the observable “Z”. The moving object information (such as a position, a velocity, and a posture angle) is estimated as the state “X”.

As the tight coupling method, a technique using the INS measurement information (such as an acceleration and an angular velocity) as the control input “U”, using the GPS measurement information (such as a code phase, a Doppler frequency, a pseudo-distance, and a pseudo-distance variation) as the observable “Z”, and using the moving object information (such as a position, a velocity, and a posture angle) as the state “X” can be used.

The position calculating method according to this embodiment can be substantially similarly applied to any coupling method described above. That is, the GPS measurement information or the GPS operation result may be applied as the GPS measurement result (first measurement result). The INS measurement information or the INS operation result may be applied as the INS measurement result (second measurement result).

Information used as the INS measurement result and the GPS measurement result can be appropriately set depending on a system to be applied. In this case, the operation expressions or the parameter values used in the prediction operation and the correction operation of the Kalman filtering process can be appropriately set depending on the system to be applied. The specific operation expressions or parameter values can be defined on the basis of known techniques and thus will not be described herein.

1-2. Setting of GPS Influence Mode

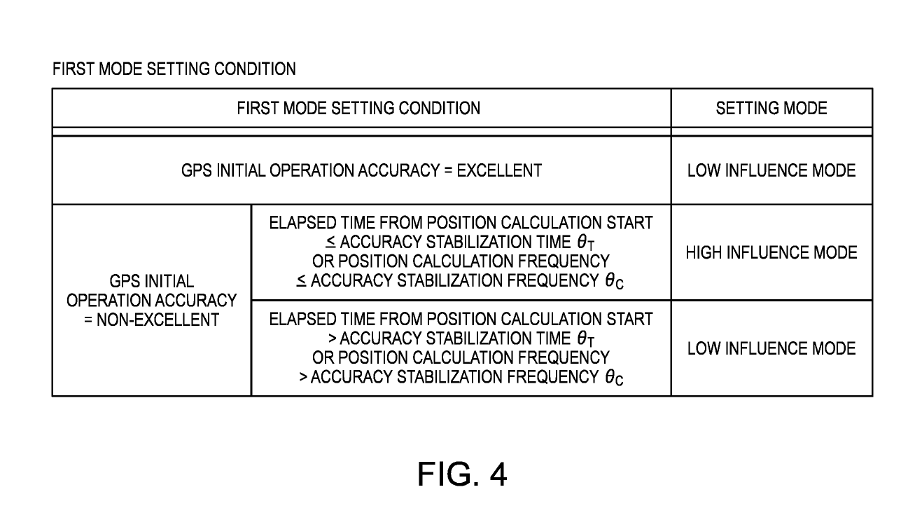

FIG. 4 is a diagram illustrating first mode setting conditions used to set a GPS influence mode and shows a first mode setting condition table in which the first mode setting conditions are determined In the first mode setting condition table, the first mode setting conditions and the setting modes are correlated with each other.

The first mode setting conditions are conditions determined on the basis of (1) GPS initial operation accuracy and (2) elapsed time after position calculation is started or position calculation frequency. The GPS initial operation accuracy is the accuracy of the initial operation result of the GPS unit 3.

The first condition is “GPS initial operation accuracy=excellent”. A “low influence mode” is determined as the setting mode satisfying this condition. That is, when “GPS initial operation accuracy=excellent” is satisfied, the GPS influence mode is switched from the initially-set “high influence mode” to the “low influence mode”. The first condition means that the GPS measurement result (first measurement result) at the time of starting the position calculation satisfies a predetermined excellent accuracy condition. When the excellent accuracy condition is satisfied, the influence level of the GPS measurement result on the INS measurement result is lowered from an initially-set first level (high influence mode) to a second level (low influence mode) lower than the first level.

The second condition is “GPS initial operation accuracy=poor”. The second condition is divided depending on the elapsed time after the position calculation is started or the position calculation frequency. The “high influence mode” is determined as the setting mode when the condition of elapsed time≦accuracy stabilization time “θ_{T}” or position calculation frequency≦accuracy stabilization frequency “θ_{c}” is satisfied. The “low influence mode” is determined as the setting mode when the condition of elapsed time>accuracy stabilization time “θ_{T}” or position calculation frequency>accuracy stabilization frequency “θ_{C}” is satisfied. That is, when “GPS initial operation accuracy=poor” is satisfied, the GPS influence mode is maintained in the initially-set “high influence mode” and is switched to the “low influence mode” at the time point at which a certain time elapses.

When the elapsed time from the start of the position calculation is greater than a predetermined accuracy stabilization time “θ_{T}” or the position calculation frequency is greater than a predetermined accuracy stabilization frequency “θ_{C}”, it corresponds to the state in which the elapsed time after starting the position calculation or the position calculation frequency satisfies an accuracy stabilizing condition defined as a temporal condition for stabilizing the accuracy of the position calculation result. When this excellent accuracy condition is satisfied, it corresponds to the state in which the influence level of the GPS measurement result on the INS measurement result is lowered from the initially-set first level (high influence mode) to the second level (low influence mode) lower than the first level.

The accuracy stabilization time “θ_{T}” or the accuracy stabilization frequency “θ_{C}” can be appropriately set depending on a system to which the position calculating method according to this embodiment is applied. For example, when the position calculating method is applied to a system that performs the position calculation at “intervals of one second”, the number of seconds in a range of “30 seconds to 60 seconds” can be effectively set as “θ_{T}” and the frequency in a range of “30 times to 60 times” can be effectively set as “θ_{C}”.

In the GPS operation, the position of a moving object is calculated using a pseudo-distance observed for each GPS satellite, for example, by performing a positioning calculation employing at least square method. The relative velocity (relative velocity vector) of a GPS satellite and the moving object is calculated on the basis of an error (frequency shift from a carrier frequency) of a reception frequency of a received GPS satellite signal, and the velocity (velocity vector) of the moving object is calculated using the calculated relative velocity. At this time, by performing a known error estimating operation, the maximum error which may be included in the calculated position or velocity (velocity vector) can be estimated.

Therefore, a threshold value of the error estimated through the error estimating operation is determined in advance. For example, “10 [m]” is determined as a threshold of a position error and “1 [m/s]” is determined as a threshold of a velocity error. The GPS initial operation accuracy is determined by performing the threshold determination on the position error and the velocity error. In this case, the GPS initial operation accuracy may be determined by applying an AND condition to the threshold determination results, or the GPS initial operation accuracy may be determined by applying an OR condition to the threshold determination results.

It is apparently considered to be contradictory that the initial operation accuracy of the GPS is excellent but the GPS influence mode is set to the “low influence mode” or that the initial operation accuracy of the GPS is non-excellent but the GPS influence mode is set to the “high influence mode”. The reason for employing this setting method is as follows.

A reference position or a reference direction is necessary for performing the position calculating process using an inertial navigation operation. Accordingly, performing a GPS operation process at the time of starting the position calculation and setting the acquired position and direction as the reference position and the reference direction of a subsequent position calculating process is considered as one technique.

When the GPS initial operation accuracy is excellent, a subsequent position calculating process can be performed with a position or direction having high accuracy as a reference. Accordingly, even when the influence level of the GPS is lowered and the position calculating process is performed with the INS emphasized, it is possible to obtain a stable operation result with relatively high accuracy for a short time.

However, when the GPS initial operation accuracy is not excellent, a subsequent position calculating process should be performed with a position or direction having low accuracy as a reference. That is, the position calculating process is initially started in a state where errors overlap. In this case, when the influence level of the GPS is lowered and the INS is emphasized, the initial error is not corrected with the lapse of time.

Therefore, the GPS influence mode is set to the “low influence mode” when the initial operation accuracy of the GPS is excellent and the GPS influence mode is set to the “high influence mode” when the GPS initial operation accuracy of the GPS is not excellent. When the position calculating process is performed in a state where the GPS influence mode is set to the “high influence mode”, the operation accuracy of the GPS is improved and thus the initial error is gradually corrected. Therefore, at a time point at which a certain time elapses, the dependency on the GPS is lowered by switching the GPS influence mode from the “high influence mode” to the “low influence mode”.

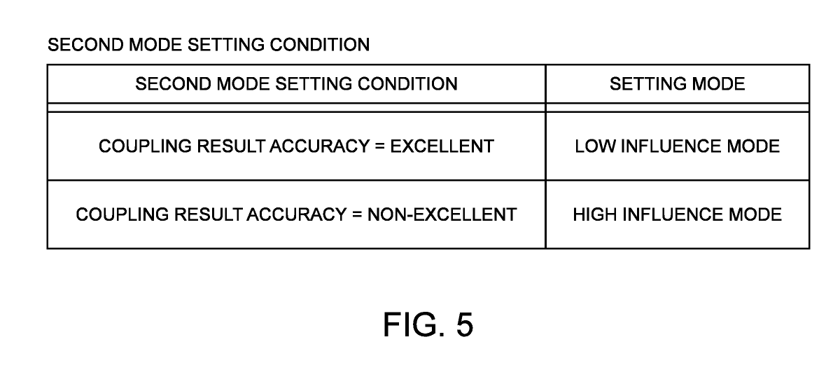

FIG. 5 is a diagram illustrating second mode setting conditions which are used to set the GPS influence mode and shows a second mode setting condition table in which second mode setting conditions are determined In the second mode setting condition table, the second mode setting conditions are correlated with setting modes.

The second mode setting conditions are conditions defined on the basis of the result of the coupling process. Specifically, “coupling result accuracy=excellent” is defined as the first condition. The “low influence mode” is defined as the setting mode when the first condition is satisfied. “Coupling result accuracy=non-excellent” is defined as the second condition. The “high influence mode” is defined as the setting mode when the second condition is satisfied.

The coupling result accuracy means accuracy of a position and the like of a moving object obtained by performing the coupling process. For example, in the Kalman filtering process, an error “P” of a state “X” to be estimated is set to perform the operation. In the prediction operation and the correction operation, the accuracy of the state “X” is determined by performing prediction and correction on the error “P” along with the state “X”. Therefore, the error “P” used in the Kalman filtering process can be used as the coupling result accuracy.

When the state “X” includes plural elements, the error “P” can be expressed by an error covariance matrix “P” in the form of matrix. In this case, the accuracy of each element can be estimated from the diagonal components of the error covariance matrix “P”. For example, when the elements of the state “X” include the position, the velocity, and the posture angle of a moving object, the diagonal components of the error covariance matrix “P” include a coupling position error, a coupling velocity error, and a coupling posture angle error.

Therefore, threshold values of the coupling position error, the coupling velocity error, and the coupling posture angle error are determined in advance. For example, “10 [m]” is determined as the threshold value of the coupling position error, “1 [m/s]” is determined as the threshold value of the coupling velocity error, and “1 [°]” is determined as the threshold value of the coupling posture angle error. The coupling result accuracy is determined by performing threshold determination on the errors. In this case, the coupling result accuracy may be determined by applying an AND condition to the threshold determination results, or the coupling result accuracy may be determined by applying an OR condition to the threshold determination results.

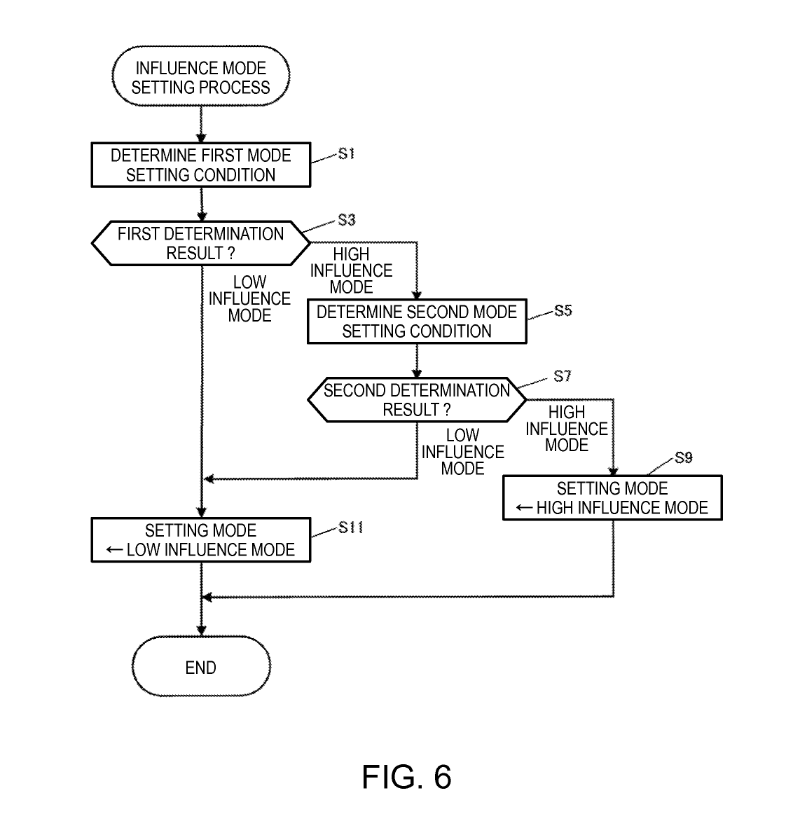

FIG. 6 is a flowchart illustrating the flow of an influence mode setting process in this embodiment. First, the influence mode setting unit 7A determines whether the first mode setting conditions are satisfied with reference to the first mode setting condition table shown in FIG. 4 (step S1). When the determination result (first determination result) thereof is the high influence mode (high influence mode in step S3), the influence mode setting unit 7A determines whether the second mode setting conditions are satisfied with reference to the second mode setting condition table shown in FIG. 5 (step S5).

When the determination result (second determination result) in step S5 is the high influence mode (high influence mode in step S7), the influence mode setting unit 7A sets the GPS influence mode to the high influence mode (step S9). On the other hand, when the first determination result in step Si is the low influence mode (low influence mode in step S3) or when the second determination result in step S5 is the low influence mode (low influence mode in step S7), the influence mode setting unit 7A sets the GPS influence mode to the low influence mode (step S11). Then, the influence mode setting process ends.

In the influence mode setting process, only when both the first determination result and the second determination result are the high influence mode, the GPS influence mode is set to the high influence mode. This is intended to lower the influence level of the GPS in a step as early as possible to perform the position calculating process.

1-3. Operation Setting

The coupling unit 9 performs the coupling process while changing the operation setting depending on the GPS influence mode. In this embodiment, the operation setting includes a GPS measurement result utilization frequency and an error parameter value used in the Kalman filtering process.

The GPS measurement result utilization frequency is an execution frequency of performing the coupling process by utilizing the GPS measurement result. In FIG. 2, the frequency by which the Kalman filtering unit 9A performs the correction operation by utilizing the GPS measurement result as the observable “Z” corresponds to the GPS measurement result utilization frequency.

When the GPS influence mode is set to the “high influence mode”, the GPS measurement result needs to strongly influence on the INS measurement result. Therefore, the GPS measurement result utilization frequency is set to a first frequency which is relatively high. On the contrary, when the GPS influence mode is set to the “low influence mode”, the influence of the GPS measurement result on the INS measurement result needs to be lowered. Therefore, the GPS measurement result utilization frequency is set to a second frequency lower than the first frequency. The second frequency has only to be lower than the first frequency and the specific value can be appropriately set.

The error parameter value is a kind of parameter value which is set in the Kalman filtering operation. In this embodiment, an observation error (observation noise) “R” corresponding to the error of the observable “Z” is described as an example of the error parameter.

In the correction operation of the Kalman filtering process, when the observation error “R” is set to be small, the state “X” is corrected to follow the observable “Z”. That is, the filter functions to follow the state “X” with the observable “Z” emphasized. On the contrary, when the observation error “R” is set to be large, the state “X” is corrected to follow the predicted state value “X-”. That is, a filter functions to follow the state “X” with the predicted state value “X-”, which has been predicted in the prediction operation, emphasized.

Accordingly, when the GPS influence mode is set to the “high influence mode”, the observation error “R” is set to a first parameter value which is relatively small so as to increase the influence of the GPS measurement result on the INS measurement result. On the contrary, when the GPS influence mode is set to the “low influence mode”, the observation error “R” is set to a second parameter value larger than the first parameter value so as to decrease the influence of the GPS measurement result on the INS measurement result. The second parameter value has only to be larger than the first parameter value and the specific value thereof can be appropriately set.

1-4. Experiment Result

Results of experiments in which the position calculating process was actually carried out using the position calculating method according to this embodiment will be described below. An experiment in which a moving object was caused to move along a predetermined path and a position calculated at this time is plotted on a two-dimensional plane of north, south, east, and west was carried out.

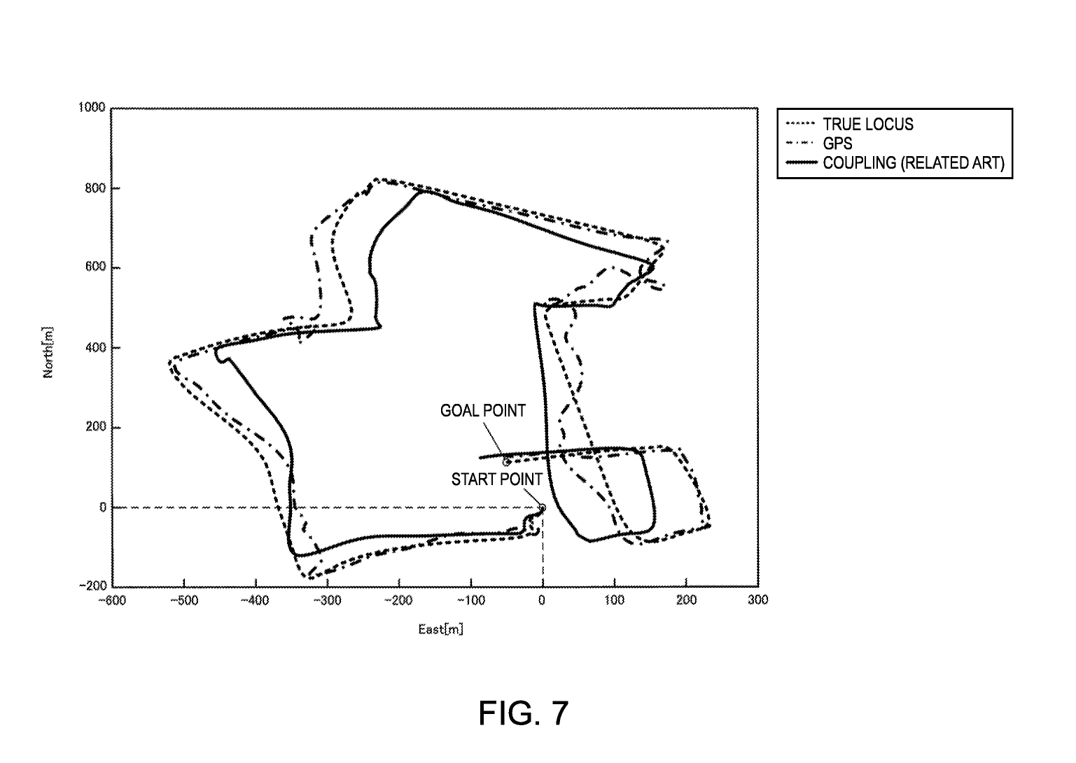

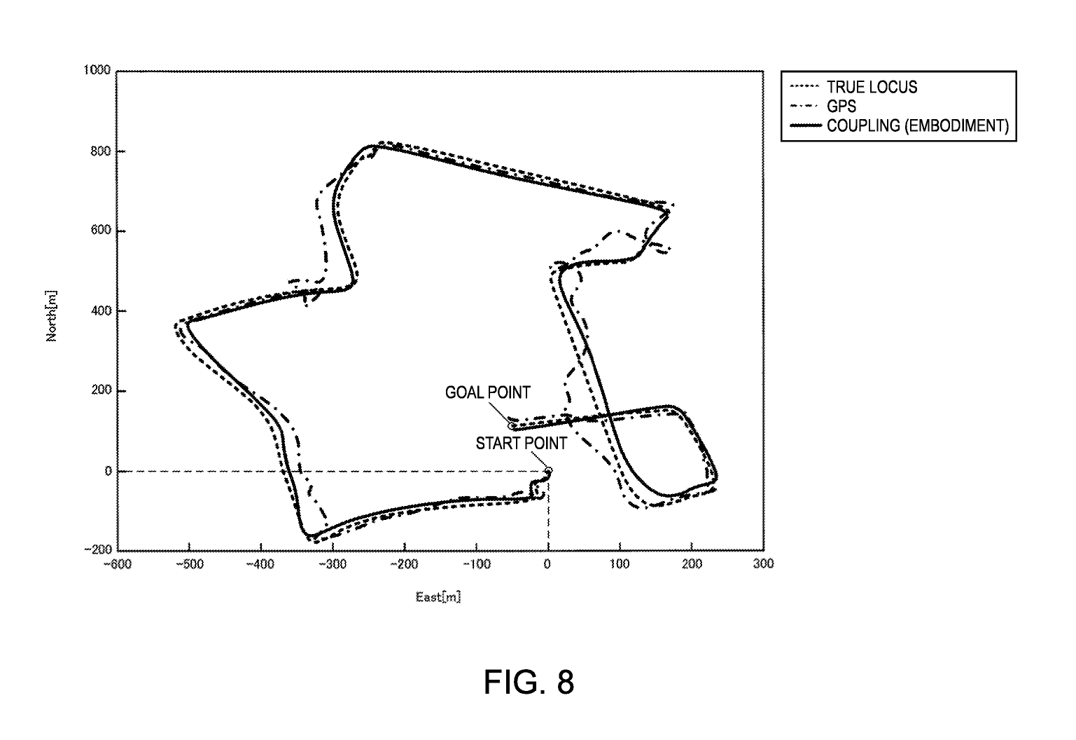

FIG. 7 shows an example of an experiment result employing the position calculating method according to the related art. FIG. 8 shows an example of an experiment result employing the position calculating method according to this embodiment. In the experiments shown in FIGS. 7 and 8, an erroneous direction deviated by 10° from a true direction was given as an initial direction to a first position calculating device 1A and the position calculating process was performed.

In the drawings, the horizontal axis represents the east-west direction and the vertical axis represents the north-south direction (of which the unit is meter). A position of “0 m” in the east-west direction and “0 m” in the north-south direction was set as a start point and a moving object was caused to travel along a path circulating in a clockwise direction from the start point to the west. A goal point was set to a predetermined position in the vicinity of the start point. The true locus of the moving object was indicated by a “dotted line”, the locus calculated using the GPS was indicated by a “one-dot chained line”, and the locus calculated using the coupling process was indicated by a “solid line”.

Referring to the result of FIG. 7 employing the technique according to the related art, since the direction given as the initial direction is deviated by “10° ”, it can be seen that the position calculation accuracy degrades due to the direction error. That is, since the moving velocity constraint condition is applied in a state where the initial direction is erroneous, the moving direction is constrained in the erroneous direction in the Kalman filtering process and the position error cumulatively increases with the lapse of time.

On the contrary, referring to the result of FIG. 8 employing the technique according to this embodiment, it can be seen that the initial direction is deviated by “10° ” but a locus along the true locus is obtained. This is because the INS operation result is appropriately corrected by the GPS operation result by performing the coupling process while setting the influence level of the GPS every time.

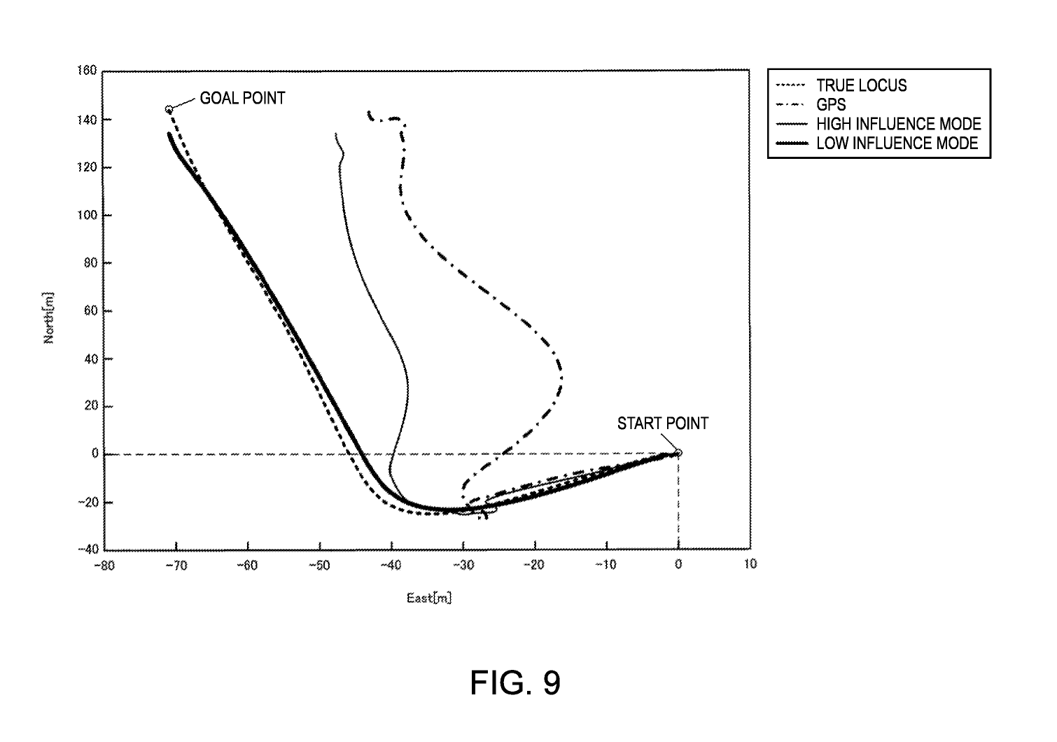

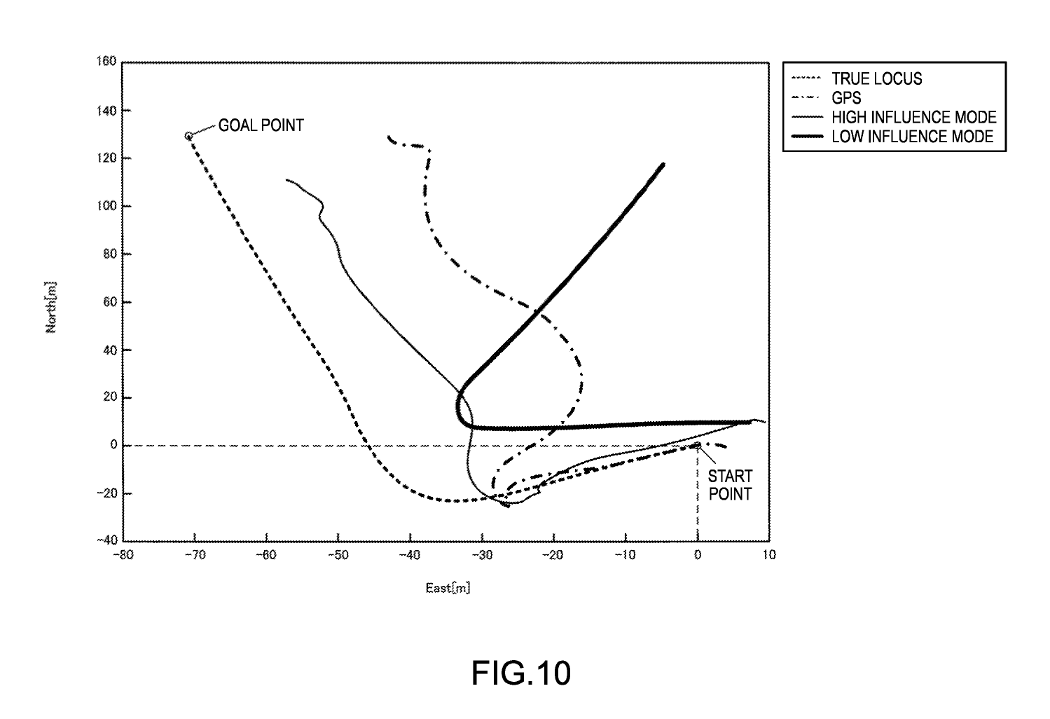

FIGS. 9 and 10 show results of an experiment representing effectiveness of the first mode setting conditions. In the first mode setting conditions described with reference to FIG. 4, the initial operation accuracy of the GPS is excellent but the GPS influence mode is set to the “low influence mode”, and the initial operation accuracy of the GPS is not excellent but the GPS influence mode is set to the “high influence mode”. The drawings show an example of the experiment result representing validity of this paradox apparently considered to be contradictory.

When the initial operation accuracy of the GPS is excellent and is not excellent, the position calculating process was performed while changing the GPS influence mode. That is, it was proved what difference appeared in the position calculation results when the GPS influence mode was set to the “low influence mode” and when the GPS influence mode was set to the “high influence mode”.

In the drawings, the horizontal axis represents the east-west direction and the vertical axis represents the north-south direction (of which the unit is meter). A position of “0 m” in the east-west direction and “0 m” in the north-south direction was set as a start point and a moving object was caused to travel along a path directed to the west and then to the north from the start point. A goal point was set to a position of “70 m” in the west direction and “140 m” in the north direction. In the drawings, the true locus of the moving object was indicated by a “dotted line”, the locus calculated using the GPS was indicated by a “one-dot chained line”, the locus calculated by setting the GPS influence mode to the high influence mode was indicated by a “thin solid line”, and the locus calculated by setting the GPS influence mode to the low influence mode was indicated by a “thick solid line”.

FIG. 9 shows an experiment result when the GPS initial operation accuracy is excellent. From this drawing, it can be seen that the initial operation accuracy of the GPS is excellent, accurate reference position and reference direction are given, and thus an accurate locus is obtained for a short time, even when the GPS influence mode is set to the high influence mode and the low influence mode. However, since the operation accuracy of the GPS is lowered at a certain time point, and a clear difference occurs therebetween.

When the GPS influence mode is set to the high influence mode, it can be seen that since the influence level of the GPS is high, the locus is attracted to an erroneous GPS operation position and the position calculation accuracy degrades in the middle. Specifically, it can be seen that the locus (thin solid line) of the calculated position is attracted to the locus (one-dot chained line) of an erroneous GPS operation position and gets apart from the true locus (dotted line).

On the contrary, when the GPS influence mode is set to the low influence mode, it can be seen that since the influence level of the GPS is low, the above-mentioned problem does not occur and the locus (thick solid line) along the true locus (dotted line) is obtained.

FIG. 10 shows an experiment result when the GPS initial operation accuracy is not excellent. Form this result, it can be seen that the locus (thick solid line) of the calculated position is greatly spaced from the true locus (dotted line) when the GPS influence mode is set to the low influence mode. That is, since the erroneous reference position and the erroneous reference direction are given, the moving direction is initially limited to an erroneous direction. The moving direction is completely deviated at a certain time point, but is not corrected because the influence level of the GPS is low, and thus the position in the erroneous direction is calculated.

On the contrary, when the GPS influence mode is set to the high influence mode, it can be seen that the locus (thin solid line) close to the true locus (dotted line) is obtained, compared with the case where the GPS influence mode is set to the low influence mode. This is because the moving direction is prevented from being limited to the erroneous direction by setting the influence level of the GPS to be high and influencing the GPS measurement result on the NS measurement result slowly with the lapse of time.

From the results shown in FIGS. 9 and 10, it is proved that it is valid to set the GPS influence mode to the “low influence mode” when the initial operation accuracy of the GPS is excellent and to set the GPS influence mode to the “high influence mode” when the initial operation accuracy of the GPS is not excellent.

2. Examples

Examples of an electronic apparatus including the position calculating device will be described below. Herein, an example of a car navigation apparatus including a position calculating device will be described. Here, examples of the invention are not limited to the following examples.

2-1. System Configuration

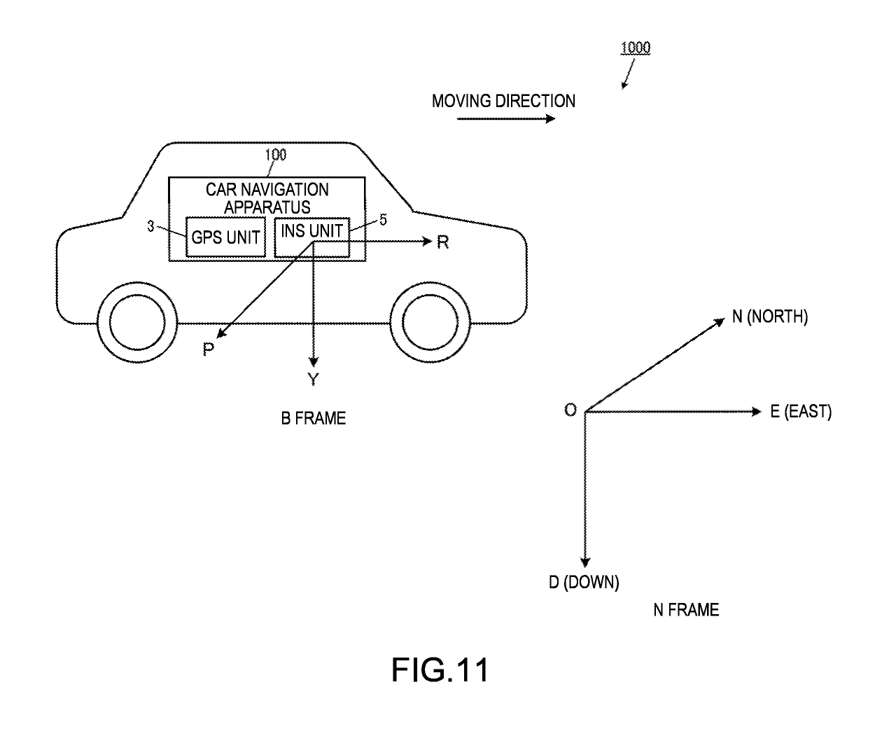

FIG. 11 is a diagram illustrating a system configuration of a navigation system 1000 according to this example. The navigation system 1000 is a system in which a car navigation apparatus 100 as a kind of electronic apparatus including a position calculating device is installed in a four-wheeled automobile (hereinafter, simply referred to as “automobile”) as a kind of moving object.

The car navigation apparatus 100 is an electronic apparatus that is installed in an automobile so as to provide a driver of the automobile with navigation guidance. The car navigation apparatus 100 includes a GPS unit 3 and an INS unit 5.

In this example, the GPS unit 3 measures and outputs GPS measurement information 55. The INS unit 5 measures and outputs INS measurement information 56 in a B frame known as a body frame. The B frame is a three-dimensional orthogonal coordinate system in which the front-rear direction with the front side of a moving object as positive is set as an R axis (roll axis), the left-right direction with the right side as positive is set as a P axis (pitch axis), and the up-down direction with the vertically-downward direction as positive is set as a Y axis (yaw axis).

The car navigation apparatus 100 performs a GPS operation process using the GPS measurement information acquired from the GPS unit 3 and performs an INS operation process using the INS measurement information acquired from the INS unit 5. The coupling process is performed on the operation results to calculate the position of the automobile and a navigation screen in which the calculated position is plotted is displayed on a display as a display unit 30.

The position of the automobile is calculated in an N frame which is an absolute coordinate system in which the moving space of the automobile is defined. The N frame is defined, for example, as an NED coordinate system known as a north-east-down coordinate system or an ECEF coordinate system known as an earth-centered earth-fixed coordinate system.

2-2. Functional Configuration

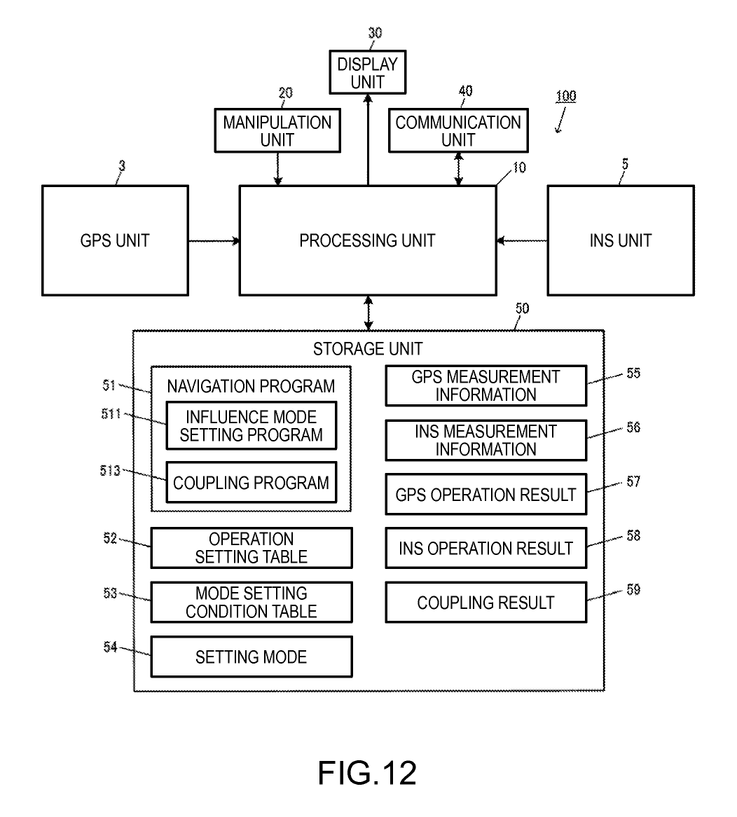

FIG. 12 is a block diagram illustrating an example of a functional configuration of the car navigation apparatus 100. The car navigation apparatus 100 includes the GPS unit 3, the INS unit 5, a processing unit 10, a manipulation unit 20, a display unit 30, a communication unit 40, and a storage unit 50.

The processing unit 10 is a control device that comprehensively controls the units of the car navigation apparatus 100 in accordance with various programs such as a system program stored in the storage unit 50 and includes a processor such as a CPU (Central Processing Unit). The processing unit 10 performs a navigation process in accordance with a navigation program 51 stored in the storage unit 50 and performs a process of displaying a map with a current position of an automobile marked thereon on the display unit 30.

The manipulation unit 20 is an input device including, for example, a touch panel or button switches, and outputs the signal of the pressed key or button to the processing unit 10. Various instruction inputs such as an input of a destination are performed by manipulating the manipulation unit 20.

The display unit 30 is a display device that includes an LCD (Liquid Crystal Display) or the like and that performs various displays based on a display signal input from the processing unit 10. The navigation screen or the like is displayed on the display unit 30.

The communication unit 40 is a communication device that transmits and receives information used in the apparatus to and from the outside through communication networks such as the Internet under the control of the processing unit 10. Known wireless communication techniques can be used in the communications.

The storage unit 50 is constructed by a storage device such as a ROM (Read Only Memory), a flash ROM, and a RAM (Random Access Memory), and stores a system program of the car navigation apparatus 100, various programs for realizing various functions such as a navigation function, data, and the like. The storage unit has a work area temporarily storing data in process of various processes and process results thereof.

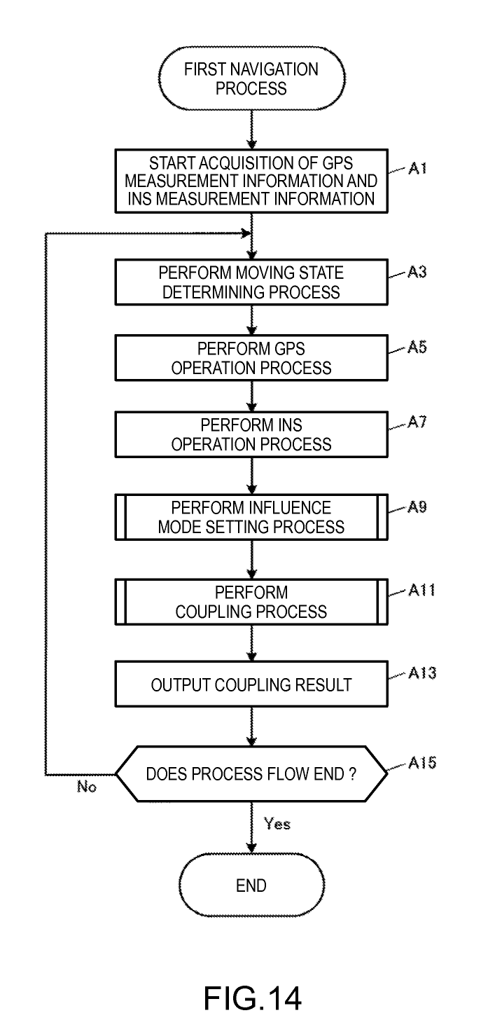

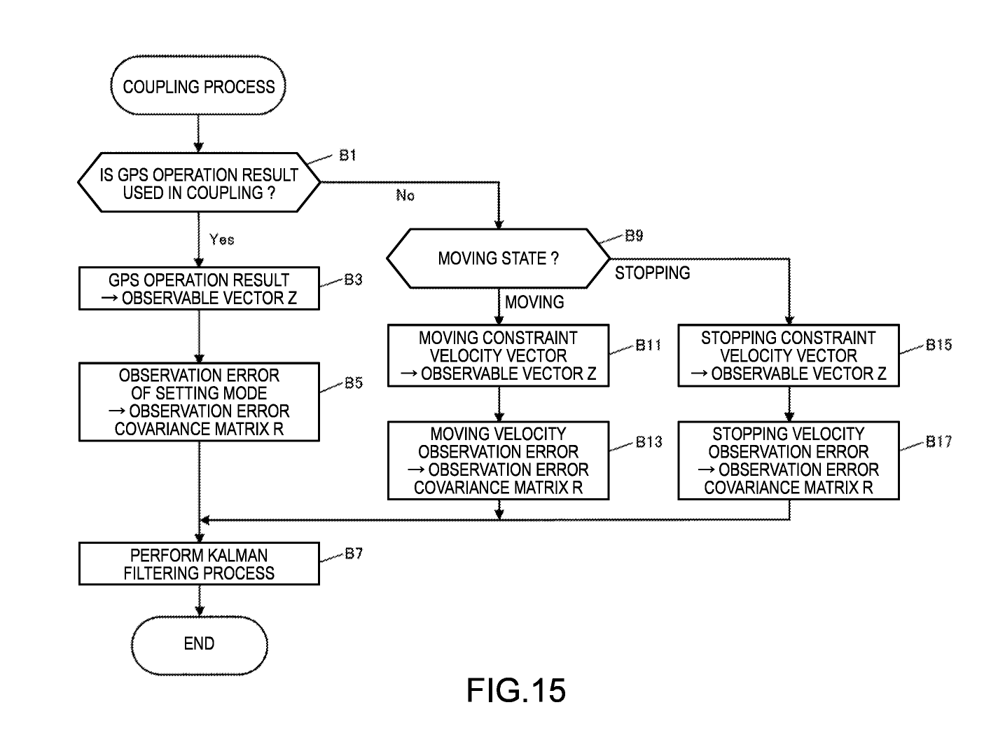

In the storage unit 50, a navigation program 51 which is read by the processing unit 10 and which is executed as various navigation processes (see FIGS. 14 to 16) is stored as the program. The navigation program 51 includes an influence mode setting program 511 which is executed as the influence mode setting process (see FIG. 6) and a coupling program 513 which is executed as the coupling process (see FIG. 15) as sub routines.

The storage unit 50 stores as the data an operation setting table 52, a mode setting condition table 53, a setting mode 54, GPS measurement information 55, NS measurement information 56, a GPS operation result 57, an INS operation result 58, and a coupling result 59.

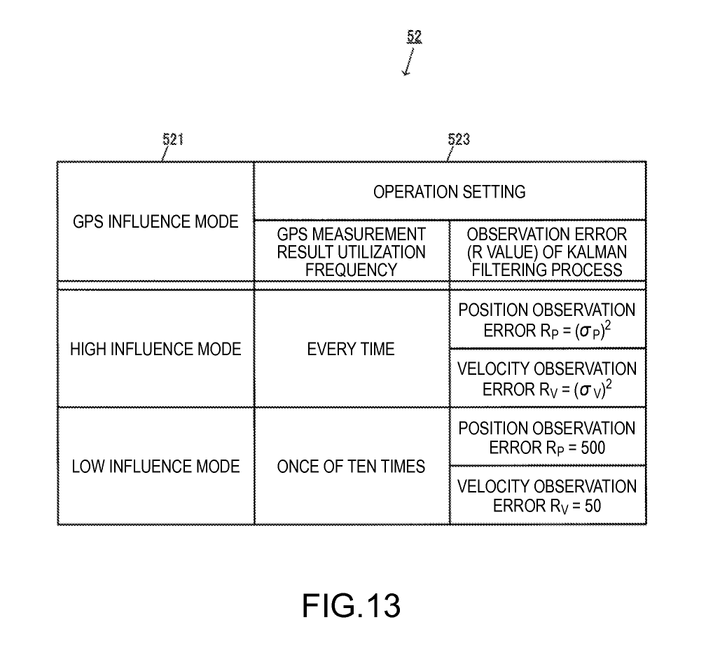

The operation setting table 52 is a table in which the operation setting is defined and a configuration example of the table is shown in FIG. 13. In the operation setting table 52, the GPS influence mode 521 and the operation setting 523 are stored in correlation with each other. For the high influence mode, “every time” (first frequency) is determined as the GPS measurement result utilization frequency. On the other hand, for the low influence mode, “once of ten times” (second frequency) is determined as the GPS measurement result utilization frequency.

That is, when the GPS influence mode is set to the high influence mode (first level), the GPS operation result is utilized every time to perform the coupling process. On the contrary, when the GPS influence mode is set to the low influence mode (second level), the GPS operation result is utilized once of ten times to perform the coupling process.

The observation error (R value) includes a position observation error “R_{P}” which is an observation error of a position and a velocity observation error “R_{V}” which is an observation error of a velocity. “R_{P}=(σp)² and R_{V}=(σ_{V})²” (first parameter value) is determined for the high influence mode. On the other hand, “R_{P}=500 and R_{V}=50” (second parameter value) are determined for the low influence mode.

“σ_{P}” and “σ_{V}” represent the position error and the velocity error included in the GPS operation result, respectively. According to the experiment performed by the inventor of the invention, the position error and the velocity error are calculated as values of about “σ_{P}=3 to 4 [m]” and “σ_{V}=0.6 to 0.8 [m/s]”, respectively, under general positioning environments. Accordingly, in the high influence mode, the value of about “10” is set as the position observation error “R_{P}” and the value of about “0.5” is set as the velocity observation error “R_{V}”. As a result, in the low influence mode, the values larger than those in the high influence mode are set as the observation error “R”.

The mode setting condition table 53 is a table in which conditions for setting the GPS influence mode are determined and includes, for example, the first mode setting condition table or the second mode setting condition table (see FIGS. 4 and 5).

The setting mode 54 is a preset GPS influence mode and is frequently updated through the influence mode setting process.

2-3. Process Flow

FIG. 14 is a flowchart illustrating a process flow of a first navigation process which is an example of the navigation process performed in accordance with the navigation program 51 stored in the storage unit 50 by the processing unit 10.

First, the processing unit 10 starts acquisition of the GPS measurement information 55 and the INS measurement information 56 from the GPS unit 3 and the INS unit 5 (step A1). Then, the processing unit 10 performs a moving state determining process (step A3). Specifically, the processing unit determines whether the automobile stops or moves, for example, on the basis of the acceleration (acceleration vector) or the angular velocity of the automobile acquired as the INS measurement information 56 from the INS unit 5.

Thereafter, the processing unit 10 performs a GPS operation process (step A5). Specifically, the processing unit calculates the position or the velocity (velocity vector) of the automobile by performing a known positioning calculation using the GPS measurement information 55 acquired from the GPS unit 3. The processing unit estimates errors of the position and the velocity (velocity vector) by performing a known error estimating operation. The operation results are stored as the GPS operation result 57 in the storage unit 50.

The processing unit 10 performs an INS operation process (step A7). Specifically, the processing unit calculates the position, the velocity (velocity vector), the posture angle of the automobile by performing a known inertial navigation operation using the INS measurement information 56 acquired from the INS unit 5. Then, the operation result is stored as the INS operation result 58 in the storage unit 50.

Subsequently, the processing unit 10 performs the influence mode setting process described with reference to FIG. 6 in accordance with the influence mode setting program 511 stored in the storage unit 50 (step A9). Then, the processing unit 10 performs the coupling process in accordance with the coupling program 513 stored in the storage unit 50 (step A11).

FIG. 15 is a flowchart illustrating the process flow of the coupling process.

The processing unit 10 determines whether the GPS operation result 57 should be utilized in the coupling process (step B1). Specifically, the processing unit determines whether the GPS operation result 57 should be utilized in this coupling process on the basis of the GPS measurement result utilization frequency correlated with the GPS influence mode set in the influence mode setting process.

When it is determined that the GPS operation result 57 is utilized in the coupling process (YES in step B1), the processing unit 10 sets an observable vector “Z” with the newest GPS operation result 57 as the observable (step B3). The processing unit sets an observation error covariance matrix “R” on the basis of the observation error corresponding to the setting mode 54 with reference to the operation setting table 52 (step B5). Then, the processing unit 10 performs the Kalman filtering process using the observable vector “Z” and the observation error covariance matrix “R” set in steps B3 and B5 (step B7).

On the other hand, when it is determined in step B1 that the GPS operation result 57 is not utilized in the coupling process (NO in step B1), the processing unit 10 determines the moving state determined in step A3 (step B9).

When the moving state is “moving” (moving in step B9), the processing unit 10 sets a moving constraint velocity vector as the observable vector “Z” (step B11). The processing unit sets the observation error covariance matrix “R” on the basis of a moving velocity observation error (for example, a predetermined value) (step B13). Then, the processing unit 10 performs the Kalman filtering process using the observable vector “Z” and the observation error covariance matrix “R” set in steps B11 and B13 (step B7).

On the other hand, when the moving state is “stopping” (stopping in step B9), the processing unit 10 sets a stopping constraint velocity vector as the observable vector “Z” (step B15). The processing unit sets the observation error covariance matrix “R” on the basis of a stopping velocity observation error (for example, a predetermined value) (step B17). Then, the processing unit 10 performs the Kalman filtering process using the observable vector “Z” and the observation error covariance matrix “R” set in steps B15 and B17 (step B7).

When the Kalman filtering process is performed in step B7, the processing unit 10 stores the result as the coupling result 59 in the storage unit 50. Then, the processing unit 10 ends the coupling process.

Referring to the first navigation process shown in FIG. 14 again, after performing the coupling process, the processing unit 10 outputs the coupling result 59 (step A13). For example, the processing unit performs a map matching process on the position (coupling position) acquired as the coupling result 59 and updates the display of the navigation screen of the display unit 30 as a result.

Subsequently, the processing unit 10 determines whether the process flow should ends (step A15). For example, when a navigation end instructing manipulation is performed by a user through the use of the manipulation unit 20, the processing unit determines that the navigation process ends. When it is determined that the process flow should not end (NO in step A15), the processing unit 10 returns the process flow to step A3. When it is determined that the process flow should end (YES in step A15), the processing unit ends the first navigation process.

3. Operational Advantages

In the position calculating device 1 including the GPS unit 3 and the INS unit 5, the influence level setting unit 7 sets the influence level of the GPS measurement result on the INS measurement result to the first level until a given condition is established after the position calculation is started, and sets the influence level to the second level lower than the first level after the given condition is established. Then, the coupling unit 9 performs the coupling process of coupling the GPS measurement result and the INS measurement result on the basis of the influence level set by the influence level setting unit 7 to calculate the position of the moving object.

For example, in the first position calculating device 1A, the influence level setting unit 7 includes the influence mode setting unit 7A. The GPS influence mode for determining the influence level of the GPS is set using the first mode setting condition determined on the basis of (1) the initial operation accuracy of the GPS and (2) the elapsed time from the start of the position calculation or the position calculation frequency and the second mode setting condition determined on the basis of the coupling result accuracy.

In the first position calculating device 1A, the coupling unit 9 includes the Kalman filtering unit 9A and performs the Kalman filtering process while changing the operation setting on the basis of the GPS influence mode set by the influence mode setting unit 7A. The operation setting includes the frequency of performing the coupling process using the GPS measurement result, and the frequency in the low influence mode is set to be lower than that in the high influence mode. The operation setting includes the observation error (R value) which is the assumed error of the GPS measurement result as the observable and the observation error in the low influence mode is set to be larger than that in the high influence mode.

In this way, by setting the influence level of the measurement result of the satellite positioning unit on the measurement result of the inertial positioning unit to be high until a given condition is established, and setting the influence level to be low after the given condition is established, it is possible to appropriately adjust the influence level at the time of initial operation of the position calculating device. Then, by changing the operation setting of the coupling process on the basis of the influence level, it is possible to enhance the effectiveness of the coupling process and to more accurately calculate the position.

4. Modified Example

Examples to which the invention can be applied are not limited to the above-mentioned examples, but can be appropriately modified without departing from the concept of the invention. In modified examples described below, the same elements as in the above-mentioned examples will be referenced by the same reference signs, description thereof will not be repeated, and differences from the above-mentioned examples will be mainly described.

4-1. Units

In the above-mentioned embodiment, the GPS unit employing the GPS is exemplified as the satellite positioning unit, but units employing other satellite positioning systems such as WAAS (Wide Area Augmentation System), QZSS (Quasi Zenith Satellite System), GLONASS (GLObal NAvigation Satellite System), and GALILEO may be used.

In the above-mentioned embodiment, the INS unit is exemplified as the inertial positioning unit, but an inertial sensor or an inertial measurement unit (IMU) measuring NS measurement information (acceleration or angular velocity) may be used as the inertial positioning unit. In this case, the processing unit of the position calculating device can be configured to perform the INS operation process using the INS measurement information measured by the inertial positioning unit.

4-2. Coupling Process

In the above-mentioned embodiment, the Kalman filtering process is exemplified as the coupling process, but the coupling process is not limited thereto. For example, an averaging process of averaging the GPS measurement result and the INS measurement result may be included in the coupling process.

A simple arithmetic average or a geometric average may be used in the averaging operation or a weighted average may be used. When the arithmetic average or the geometric average is used, for example, the frequency of performing the averaging process using the GPS measurement result may be determined as the operation setting of the coupling process. In the high influence mode, the frequency is set to be high so as to cause the GPS measurement result to strongly influence the INS measurement result. In the low influence mode, the frequency is set to be low so as to cause the GPS measurement result to weakly influence the INS measurement result.

When the weighted average is used, for example, the weight of the weighted average may be determined as the operation setting of the coupling process. In the high influence mode, the weight of the GPS measurement result is set to be large so as to more emphasize the GPS measurement result than the NS measurement result and to weighted-average the GPS measurement result. In the low influence mode, the weight of the GPS measurement result is set to be small so as to more emphasize the INS measurement result than the GPS measurement result and to weighted-average the INS measurement result.

4-3. Influence Mode Setting Method

In the above-mentioned embodiment, the GPS influence modes is set using the first mode setting condition and the second mode setting condition together, but the GPS influence mode may be set using only the first mode setting condition or the GPS influence mode may be set using only the second mode setting condition.

In the above-mentioned embodiment, the first mode setting condition is defined as a combined condition of (1) the GPS initial operation accuracy and (2) the elapsed time from the start of the position calculation or the position calculation frequency, but the conditions (1) and (2) may be defined independently. That is, the GPS influence modes may be set using only the condition based on (1) the GPS initial operation accuracy or the GPS influence mode may be set using only the condition based on (2) the elapsed time from the start of the position calculation or the position calculation frequency.

4-4. Processing Entity

In the above-mentioned examples, it is stated that the processing unit 10 of the electronic apparatus performs the GPS operation process using the GPS measurement information 55 acquired from the GPS unit 3 and the processing unit 10 performs the INS operation process using the INS measurement information 56 acquired from the INS unit 5. That is, the processing entities of the GPS operation process, the INS operation process, and the coupling process are the processing unit 10 of the electronic apparatus. This configuration may be modified as follows.

The GPS unit 3 performs the GPS operation process using the GPS measurement information 55, obtains the GPS operation result 57, and outputs the GPS operation result to the processing unit 10. The INS unit 5 performs the INS operation process using the INS measurement information 56, obtains the INS operation result 58, and outputs the INS operation result to the processing unit 10.

Then, the processing unit 10 performs the coupling process of coupling the GPS operation result 57 and the INS operation result 58 acquired from the units. That is, in this case, the processing entities of the GPS operation process and the INS operation process are the GPS unit 3 and the INS unit 5, and the processing entity of the coupling process is the processing unit 10 of the electronic apparatus.

4-5. Position Calculating Method

A position calculating method suitable for the set influence mode (influence level) may be performed to calculate the position of a moving object. For example, a predetermined position calculating process using the GPS measurement result may be performed to calculate the position when the GPS influence mode is set to the high influence mode, and the coupling process using the GPS measurement result and the NS measurement result may be performed to calculate the position when the GPS influence mode is set to the low influence mode.

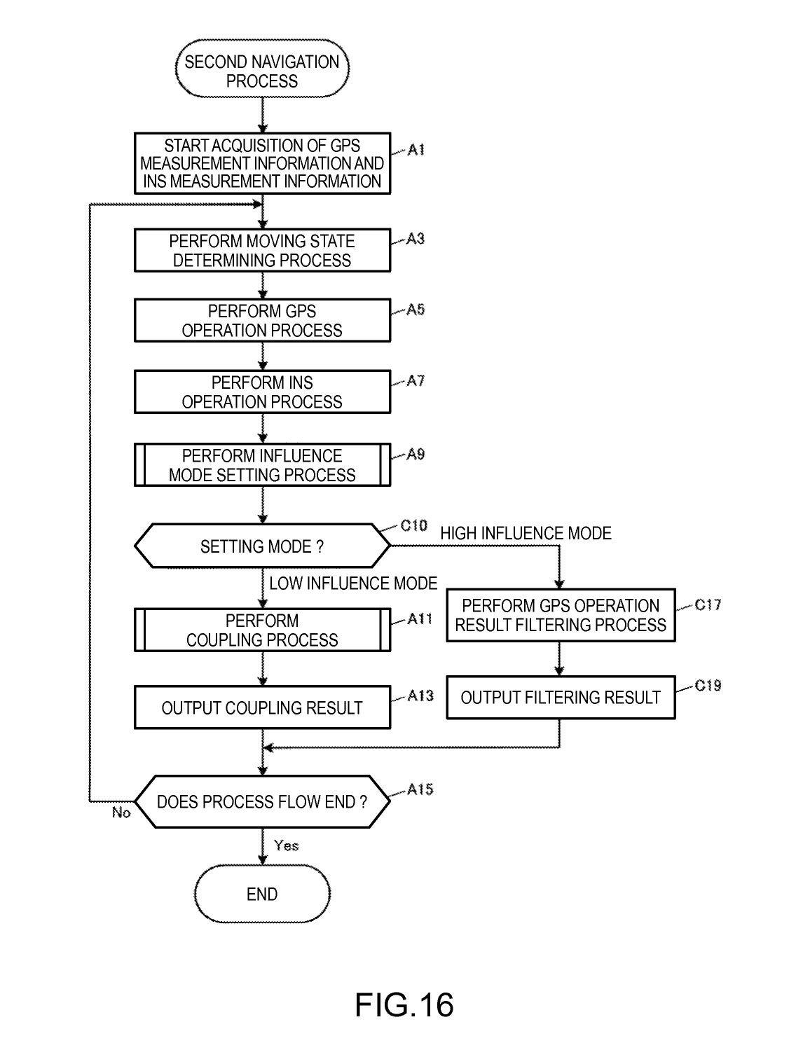

FIG. 16 is a flowchart illustrating the process flow of a second navigation process which is performed by the processing unit 10 instead of the first navigation process shown in FIG. 14. The processing unit 10 first performs the influence mode setting process in step A9 and then determines the mode (setting mode 54) set through the influence mode setting process (step C10).

When it is determined that the setting mode 54 is the high influence mode (high influence mode in step C10), the processing unit 10 performs a GPS operation result filtering process (step C17). Then, the processing unit 10 outputs the filtering result (step C19).

On the other hand, when it is determined that the setting mode 54 is the low influence mode (low influence mode in step C10), the processing unit 10 performs the coupling process described with reference to FIG. 15 (step A11). Then, the processing unit 10 outputs the coupling result 59 (step A13).

The GPS operation result filtering process of step C17 is a position calculating process of calculating a more accurate position by filtering the GPS operation result acquired through the GPS operation process of step A5. In this case, various methods can be used as the filtering method. For example, the Kalman filtering process may be performed or a filtering process based on the past history of the GPS operation result may be performed.

When the Kalman filtering process is performed, a technique of estimating the state “X” such as the position or the velocity of a moving object, for example, using the GPS operation result as the control input “U” and using the moving velocity constraint condition or the stopping velocity constraint condition described in the above-mentioned embodiment as the observable “Z” may be used.

When the filtering process based on the past history of the GPS operation result is performed, for example a technique of averaging the GPS operation results corresponding to a predetermined past period (for example, 10 seconds) and estimating the position or the velocity of a moving object can be used.

4.6. Electronic Apparatus

The above-mentioned embodiment discloses an example where the invention is applied to a navigation apparatus mounted on a four-wheeled automobile, but the electronic apparatus to which the invention can be applied is not limited to the example. For example, the invention may be applied to a navigation apparatus mounted on a two-wheeled automobile or may be applied to a portable navigation apparatus.

The invention may be similarly applied to electronic apparatuses other than a navigation apparatus. For example, the invention may be similarly applied to other electronic apparatuses such as a mobile phone, a PC, and a PDA (Personal Digital Assistant) to realize position calculation of the corresponding electronic apparatuses.

1. A position calculating method of calculating a position of a moving object using a first measurement result of a satellite positioning unit disposed in the moving object and a second measurement result of an inertial positioning unit disposed in the moving object, comprising:
setting an influence level of the first measurement result on the second measurement result to a first level until a given condition is established after position calculation is started, and setting the influence level to a second level lower than the first level after the given condition is established; and
calculating the position of the moving object by performing a coupling process of coupling the first measurement result and the second measurement result on the basis of the influence level.

2. The position calculating method according to claim 1, wherein the influence level includes a frequency of performing the coupling process using the first measurement result,
wherein the setting to the first level includes setting the frequency to a first frequency,
wherein the setting to the second level includes setting the frequency to a second frequency lower than the first frequency, and
wherein the calculating of the position includes performing the coupling process using the first measurement result on the basis of the frequency.

3. The position calculating method according to claim 1, wherein the coupling process includes a Kalman filtering process using the first measurement result as an observable,
wherein the influence level includes an error parameter value used in the Kalman filtering process,
wherein the setting to the first level includes setting the error parameter value to a first parameter value,
wherein the setting to the second level includes setting the error parameter value to a second parameter value larger than the first parameter value, and
wherein the calculating of the position includes performing the Kalman filtering process using the first measurement result and the error parameter value.

4. The position calculating method according to claim 1, wherein the calculating of the position includes calculating the position by performing a predetermined position calculating process using the first measurement result when the influence level is set to the first level, and calculating the position by performing the coupling process when the influence level is set to the second level.

5. The position calculating method according to claim 1, wherein the setting of the influence level includes determining that the given condition is established when the elapsed time after the position calculation is started or the position calculation frequency satisfies an accuracy stabilizing condition determined as a temporal condition for stabilizing the accuracy of the position calculation result.

6. The position calculating method according to claim 1, wherein the calculating of the position includes setting the position calculated from the first measurement result at the time of starting the position calculation as a reference position for subsequent position calculation, and
wherein the setting of the influence level includes determining that the given condition is established when the first measurement result at the time of starting the position calculation satisfies a predetermined excellent accuracy condition.

7. The position calculating method according to claim 1, wherein the setting of the influence level includes determining that the given condition is established when the result of the coupling process satisfies a predetermined excellent accuracy condition.

8. A position calculating device calculating a position of a moving object using a first measurement result of a satellite positioning unit disposed in the moving object and a second measurement result of an inertial positioning unit disposed in the moving object, comprising:
an influence level setting unit that sets an influence level of the first measurement result on the second measurement result to a first level until a given condition is established after position calculation is started, and sets the influence level to a second level lower than the first level after the given condition is established; and
a coupling unit that calculates the position of the moving object by performing a coupling process of coupling the first measurement result and the second measurement result on the basis of the influence level.
